(19) United States
(12) Patent Application Publication
(10) Pub. No.: US 2005/0272279 A1
(43) Pub. Date: Dec. 8, 2005

(54) Socket connector having two-piece housing

(76) Inventors: Robert G. McHugh, Golden, CO (US); Sung-Pei Hou, Tu-Chen (TW); Yao-Chi Huang, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/860,429

(22) Filed: Jun. 2, 2004

(51) Int. Cl. H01R 13/514

(52) U.S. Cl. 439/71

(57) ABSTRACT

A socket connector (20) includes an insulative housing (21) and a plurality of terminals (22) received in the housing. The housing includes a base (210) mounted on a printed circuit board (PCB) and a frame (211) surrounding the base, the base and the frame being made of different materials. A pair of bolts (23) is provided for assembling the base and the frame. The base forms a pair of aligning posts (2101, 2102) and a pair of first whorl holes (2103). The frame defines a pair of aligning holes (2112, 2113) and a pair of second whorl holes (2114). During the assembling course, the two aligning posts are respectively placed into the aligning holes, and the bolts are assembled together with the base and the frame via the two whorl holes.

### BACKGROUND OF THE INVENTION

1. Field of the Invention

The present invention relates to a socket connector for electrically connecting an integrated circuit to a printed circuit board, especially to a land grid array socket connector having a two-piece housing.

2. Description of the Prior Art

Modern computer systems increase in performance and complexity at a very rapid pace, driven by intense competition and market demands. In order to meet ever-increasing performance requirements, the area and volumetric interconnect densities of electronic board assemblies must increase accordingly. In combination with other competitive forces, this demand has driven the need for improved high-density socket technologies in computer applications, and the connector industry has responded with a variety of new alternatives to meet these needs. One of the most attractive of the new connector types is the land grid array (LGA) socket connector, which permits direct electrical connection between an LGA integrated circuit and a printed circuit board. An LGA socket connector is an evolving technology in which an interconnection between mating surfaces of an IC or other area array device and a printed circuit board is provided through conductive terminals received in the socket connector. Connection is achieved by mechanically compressing the IC onto the socket connector.

FIG. 4 shows a conventional LGA socket connector 10 for connecting an IC (not shown) to a printed circuit board (PCB) (not shown). The socket connector 10 comprises an insulative housing 12 and a plurality of terminals 14 accommodated in the housing 12. The insulative housing 12 defines a bottom wall 120 and a two pairs of sidewalls 122 surrounding the bottom wall 120. The bottom wall 120 defines a plurality of passageways 1200 therethrough for engagingly receiving the corresponding terminals therein. The sidewalls 122 form a plurality of protrusions 1220 thereon for restricting the IC in a recessed area formed by the sidewalls 122 and the bottom wall 120.

As shown, the housing 12 of the socket connector 10 is one-piece structure. The bottom wall 120 is somewhat thin and the sidewalls 122 are relatively thicker. After the housing 12 is molded, during the cooling course, the bottom wall 120 and the sidewalls 122 endure different heat-stress. Thus, the bottom wall 120 will be warped and the passageways 1200 will be shoved or skewed. As a result, the terminals 14 cannot be placed in the passageways 1200 correctly. Even though the terminals 14 are placed in the passageways 1200, the socket connector 10 cannot provide reliable electrical connection between the IC and the PCB.

Hence, a new socket connector which overcomes the above-described disadvantages is desired.

### SUMMARY OF THE INVENTION

Accordingly, a primary object of the present invention is to provide a socket connector which has a reliable structure and can perform securely electrical connection between an integrated circuit and a printed circuit board.

In order to achieve the above-mentioned object, a socket connector in accordance with a preferred embodiment of the present invention comprises an insulative housing and a plurality of terminals received in the housing. The housing comprises a base mounted on a printed circuit board (PCB) and a frame surrounding the base, wherein the base and the frame are made of different materials. A pair of bolts is provided for assembling the base and the frame together. Said base defines a plurality of passageways therethrough for accommodating the corresponding terminals therein. The base arranges a pair of aligning posts and a pair of first whorl holes. The frame defines a pair of aligning holes and a pair of second whorl holes. During the assembling course, the two aligning posts are respectively placed into the aligning holes, and the bolts are assembled together with the base and the frame via the two whorl holes.

Other objects, advantages and novel features of the present invention will become more apparent from the following detailed description when taken in conjunction with the accompanying drawings, in which:

### BRIEF DESCRIPTION OF THE DRAWINGS

FIG. 1 is a simplified, exploded, isometric view of a socket connector in accordance with a preferred embodiment of the present invention;

FIG. 2 is an assembled, isometric view of the socket connector;

FIG. 3 is an inverted, isometric view of FIG. 2; and

FIG. 4 is an isometric view of a conventional socket connector.

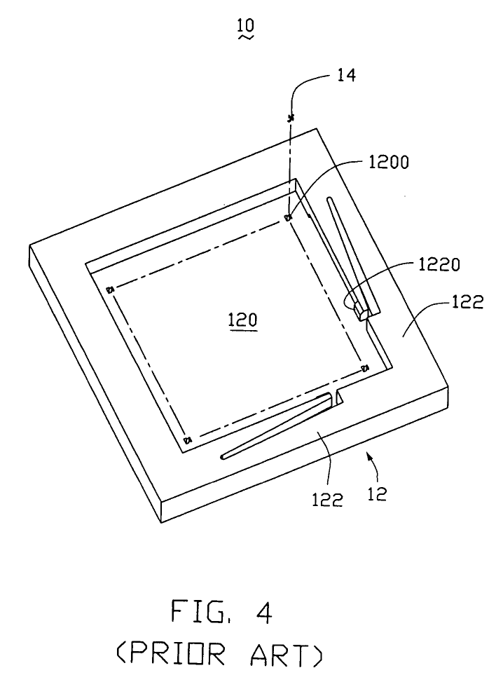

### DESCRIPTION OF THE PREFERRED EMBODIMENT

Reference will now be made to the drawing figures to describe the present invention in detail.

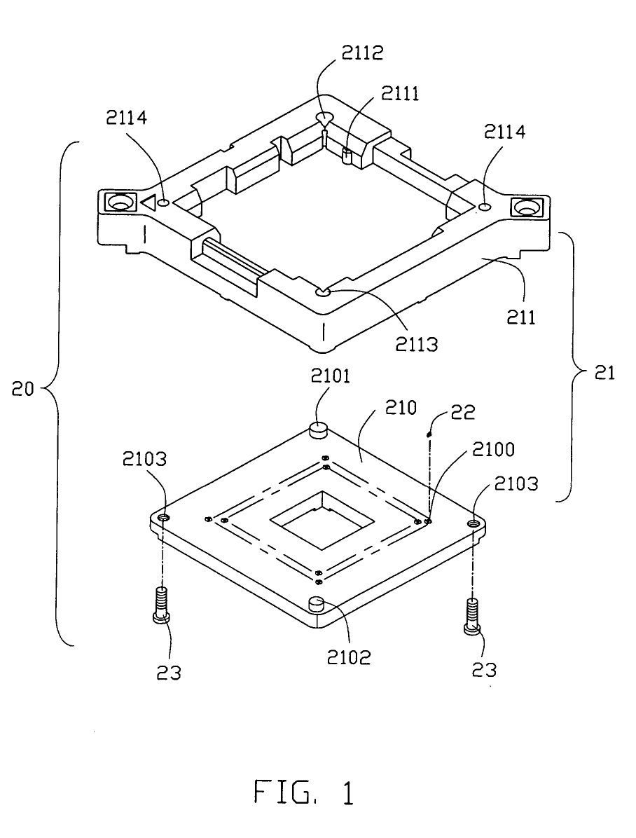

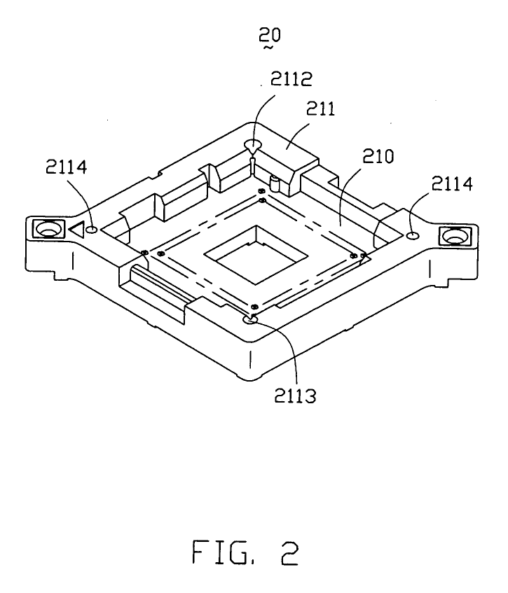

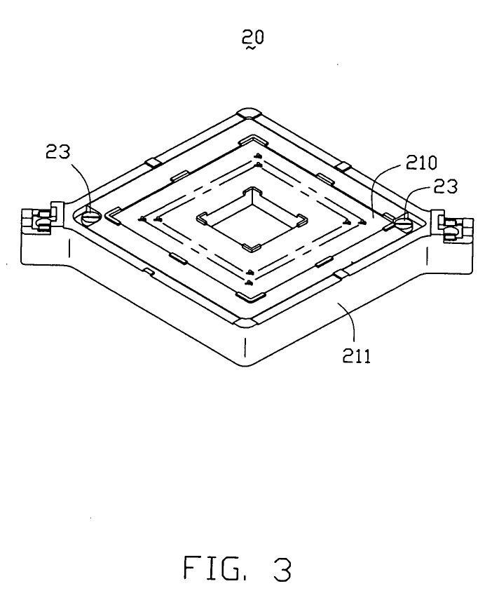

Referring to FIGS. 1-3, a socket connector 20 in accordance with a preferred embodiment of the present invention is adapted to electrically connect an integrated circuit (IC) (not shown) to a printed circuit board (PCB) (not shown). The socket connector 20 comprises an insulative housing 21 defining a recessed area (not labeled) for receiving the IC therein, a multiplicity of conductive terminals 22 received in the housing 21, and a pair of bolts 23 screwed in the housing 21.

The housing is two-piece structure and comprises a base 210 and a frame 211. The base 210 and the frame 211 are generally made of different materials. For example, the base 210 is made of Liquid Crystal Polymer (LCP) and the frame 211 is made of Polyphenylene Sulfide (PPS). The base 210 defines a multiplicity of passageways 2100 therethrough for accommodating the corresponding conductive terminals 22 therein. The base 210 forms a pair of aligning posts on a peripheral portion along a diagonal direction thereof. The aligning posts include a first aligning post 2101 with a greater diameter and a second aligning post 2102 with a smaller diameter. The base additionally defines a pair of first whorl holes 2103 on the peripheral portion along the other diagonal direction thereof.

The frame 211 is mounted on the peripheral portion of the base 210 and defines a plurality of protrusions 2111 extending into the recessed area for restricting the IC in the recessed area. The frame 211 defines a pair of aligning holes including a first aligning hole 2112 corresponding to the first aligning post 2101 and a second aligning hole 2113 corresponding to the second aligning post 2102. According to the first whorl holes 2103, the frame 211 defines a pair of second whorl holes 2114.

When the base 210 and the frame 211 are assembled together, the first aligning post 2101 and the second aligning post 2102 are respectively received in the corresponding first aligning hole 2112 and the second aligning hole 2113. The two bolts 23 are screwed in the first whorl hole 2103 of the base 210 and the second whorl hole 2114 of the frame 211. Thus, the base 210 and the frame 211 are toughly combined together.

The first aligning post 2101 is wider than the second aligning post 2012 and the first aligning hole 2112 is also wider than the second aligning hole 2113, which enables the frame 211 to be mounted on the base 210 in a sole direction. The base 210 and the frame 211 are made of different material and are molded separately, which can avoid distortion of the base caused by the different heat-stress.

While the present invention has been described with reference to specific embodiment, the description is illustrative of the invention and is not to be construed as limiting the invention. Various modifications to the present invention can be made to the preferred embodiment by those skilled in the art without departing from the true spirit and scope of the invention as defined by the appended claims.

1. A socket connector for electrically connecting an integrated circuit to a printed circuit board comprising:
an insulative housing including a base mounted on the printed circuit board and a frame assembled with the base, wherein the base defines at least two aligning posts with different diameter and a pair of first whorl holes, and the frame defines at least two aligning holes corresponding to the at least two aligning posts and a pair of second whorl holes corresponding to the first whorl holes;
a multiplicity of conductive terminals accommodating in the base;
at least two bolts screwed in the base and the frame via the first and second whorl holes, for toughly assembling the base and the frame.

2. The socket connector as described in claim 1, wherein the two aligning posts are arranged on a peripheral portion of the base along a diagonal direction of the base.

3. The socket connector as described in claim 2, wherein the first and second whorl holes are defined in the peripheral portion of the base along the other diagonal direction of the base.

4. The socket connector as described in claim 1, wherein the base and the frame are made of different materials.

5. A socket connector, for electrically connecting an integrated circuit to a printed circuit board, comprising:
an insulative housing including a base to be mounted on the printed circuit board and a frame assembled with the base;
a plurality of conductive terminals accommodating in the base, each terminal comprising an end for connecting to the integrated circuit and another end for connecting to the printed circuit board;
the base defining a first aligning post and a second aligning post on a peripheral portion of the base, the first aligning post being wider than the second aligning post;
the frame defining a first aligning hole corresponding to the first aligning post and a second aligning hole corresponding to the second aligning post.

6. The socket connector as described in claim 5, wherein the two aligning posts are arranged on a peripheral portion of the base along a diagonal direction of the base.

7. The socket connector as described in claim 5, wherein the base defines a pair of first whorl holes and the frame defines a pair of second whorl holes corresponding to the first ones.

8. The socket connector as described in claim 7 further including a pair of bolts screwed in the first and second whorl holes.

9. The socket connector as described in claim 8, wherein the whorl holes are defined in the peripheral portion of the base along the other diagonal direction of the base.

10. The socket connector as described in claim 5, wherein the base and the frame are made of different materials.

11. A socket connector, for electrically connecting an integrated circuit to a printed circuit board, comprising:
an insulative housing including a base to be mounted on the printed circuit board and a frame discrete from while assembled with the base; and
a plurality of conductive terminals accommodating in the base, each terminal comprising an end for connecting to the integrated circuit and another end for connecting to the printed circuit board; wherein
the housing is made of first material having superior liquidity character during molding, while the frame is made of second material having superior strength and anti-electrostatic character.
